(19) United States
(12) Patent Application Publication
(10) Pub. No.: US 2013/0275920 A1
(43) Pub. Date: Oct. 17, 2013

(54) SYSTEMS AND METHODS FOR RE-ORIENTATION OF PANORAMIC IMAGES IN AN IMMERSIVE VIEWING ENVIRONMENT

(71) Applicant: TourWrist, Inc., (US)

(72) Inventor: Charles Robert Armstrong, San Francisco, CA (US)

(21) Appl. No.: 13/837,395

(22) Filed: Mar. 15, 2013

Related U.S. Application Data
(63) Continuation-in-part of application No. 13/733,908, filed on Jan. 4, 2013.
(60) Provisional application No. 61/584,183, filed on Jan. 6, 2012.

(30) Foreign Application Priority Data
Jan. 5, 2013 (US) PCT/US2013/020427

(51) Int. Cl. G06F 3/0481

(52) U.S. Cl. CPC G06F 3/04815
USPC 715/850

(57) ABSTRACT

A computerized display device re-orientates panoramic images in a limited field-of-view immersive viewing environment. The display device orientates to affect the field of view (FOV) of a corresponding virtual panoramic reality FOV. Upon executing a user command, the orientation within the immersive viewing environment is disassociated from the orientation of the device in the real world. The device tracks changes in orientation, and detects when the change in orientation exceeds a threshold, and if so, smoothly re-orientate the virtual panoramic reality orientation and FOV to correspond to device orientation and implied FOV.

### CROSS REFERENCE TO RELATED APPLICATIONS

This application is a continuation-in-part application and claims the benefit of application Ser. No. 13/733,908 filed on Jan. 4, 2013, entitled “Systems and Methods for Acceleration-Based Motion Control of Virtual Tour Applications”, which application claims priority to U.S. Provisional Application No. 61/584,183 filed on Jan. 6, 2012, of the same title, both applications are incorporated herein in their entirety by this reference.

### BACKGROUND

The present invention relates to systems and methods for controlling the immersive viewing experience of a panoramic image.

There are a number of software programs that allow for the immersive viewing and control of panoramic images. Recently many of them have taken advantage of the motion sensors available on the devices on which they reside. This allows for the orientation of the viewer to correlate to the orientation of the device, thus allowing for a more immersive experience. For some use-cases, though, the motion-sensor controlled orientation is not desirable, for that reason a hybrid of touch and sensor based control is utilized.

While this is mostly sufficient, it introduces an interesting but troublesome problem best illustrated with using the horizon as a reference. If one is moving the device in such a way that he directs the view at the sky, but then use touch to reorient the view such that, even though the device is aimed at the sky, the horizon will be at the center of the view. Now the viewer is in such a state that the orientation of the panorama does not correlate to the real world. If one were to then move the device while in this hybrid control mode, the disconnect between the orientation of the viewer and the real world would remain.

It is therefore apparent that an urgent need exists for allowing any number of control paradigms to co-exist with motion controlled panoramic viewing. This improved system enables a seamless, enjoyable and less disorienting experience of displaying and controlling panoramic images.

### SUMMARY

To achieve the foregoing and in accordance with the present invention, systems and methods for viewing panoramic images is provided. In particular the systems and methods for restoring a more-natural experience when using multiple control paradigms to alter the direction and/or field of view of a panoramic image displayed by a computerized device.

In one embodiment, a computerized display device is configured to re-orientate panoramic images in a limited field-of-view immersive viewing environment. The display device, e.g., a mobile device, orientates to affect the field of view (FOV) of a corresponding virtual panoramic reality FOV. Upon executing a user command, the orientation within the immersive viewing environment is disassociated from the orientation of the device in the real world. The device then changes the method of controlling the orientation of the panoramic FOV to the method through which the user command was issued. The device tracks changes in orientation, and detects when the change in orientation exceeds a threshold, and if so, smoothly re-orientate the virtual panoramic reality orientation and FOV to correspond to device orientation and implied FOV.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an exemplary flow diagram illustrating a scenario in which a disconnect occurs between the panoramic view and reality orientation of the device and is subsequently resolved, in accordance with one embodiment of the present invention;

FIG. 2 is a screenshot illustrating an initial state of the view of a panoramic image displayed on a mobile device as it correlates to the real world for the embodiment of FIG. 1;

FIG. 3 is a perspective view of an exemplary display device such as a mobile device superimposed on an environment and illustrating the state of the view of a panoramic image displayed on a mobile device with a specified altered orientation for the embodiment of FIG. 1;

FIG. 4 illustrates the state of the view of a panoramic image displayed on a mobile device as it has been altered by a secondary control mechanism;

FIG. 5 illustrates the initial state of the view of a panoramic image displayed on a mobile device rotated back to its initial state and the view has become disassociated from the real world for the embodiment of FIG. 1; and

FIG. 6 illustrates the gradual restoration of the correlation between the real world and the panoramic view.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

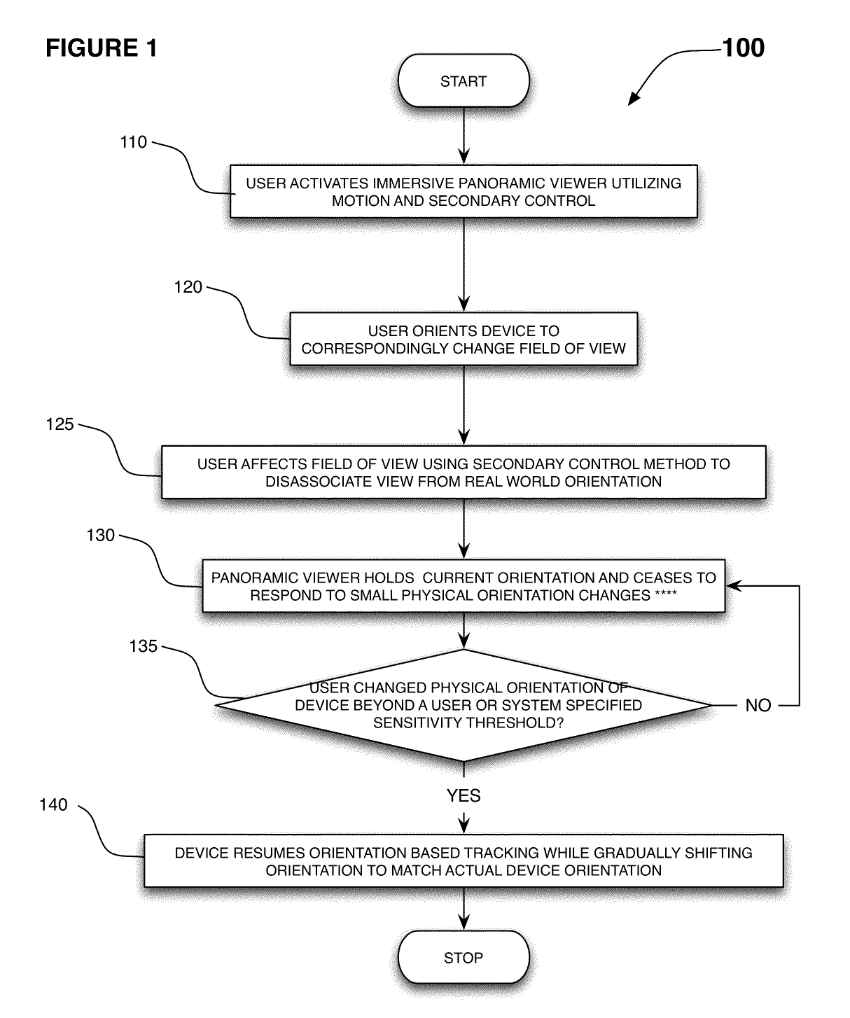

The present invention relates to systems and methods for a reorientation of panoramic images in an immersive viewing environment. To facilitate discussion, FIG. 1 is a flow diagram illustrating orienting a device field of view (FOV), disassociating the device FOV from the virtual panoramic reality FOV, and then reorienting the device image as needed. Note that display devices can be any one of, for example, personal computers, laptops, tablets, smart phones, video game systems, their peripherals, and television monitors.

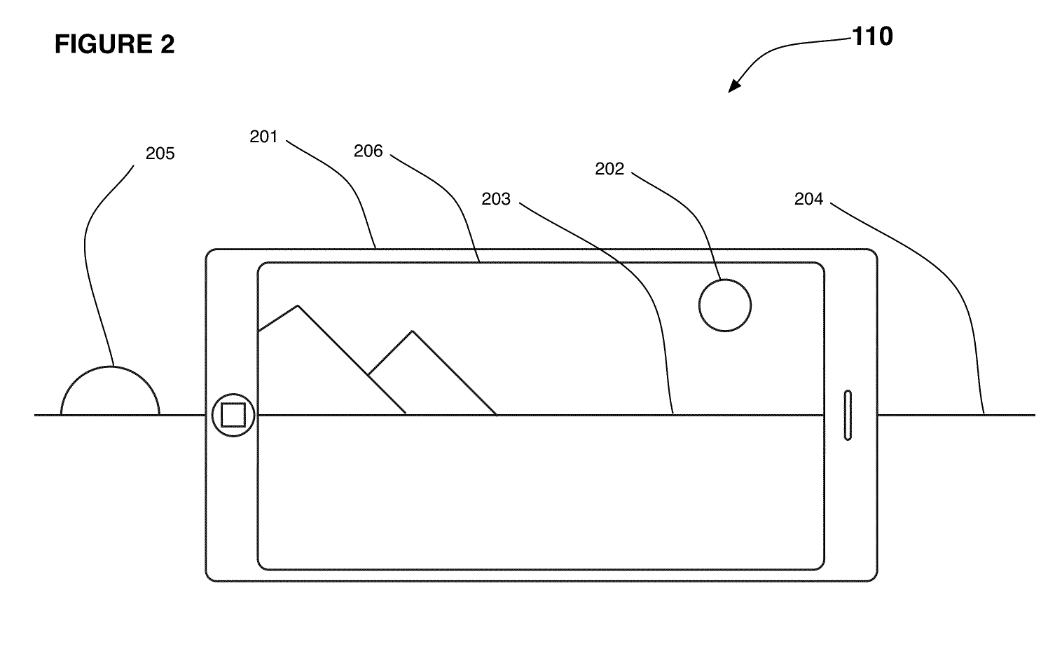

FIG. 2 shows the view of a panoramic image 206 displayed on a mobile device 201 equipped with motion and touch sensors. In steps 110 and 120, a user of a display device 201 selects an immersive panoramic viewer utilizing motion and secondary control, and begins orienting device 201 to any detected corresponding change in the virtual panoramic reality FOV. Detection of change can be accomplished by a variety of techniques including motion sensor(s) such as gyroscope(s) and accelerometer(s).

Note that the virtual panoramic reality FOV 206 can be that of a different location than that of the real world of the user as the sun is setting in the user's real world 205, 204 and in the view of the panoramic image 206, the sun 202 is above the virtual panoramic reality horizon 203.

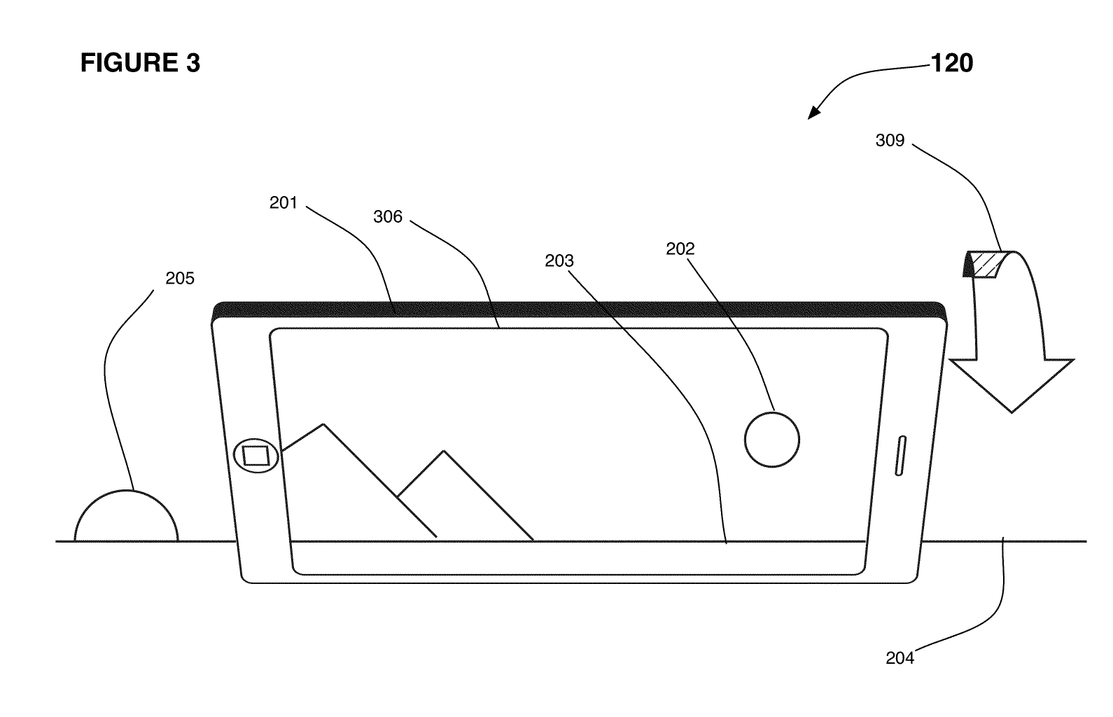

FIG. 3 shows the display device 201 being oriented with the top edge moving towards the user 309. Although the motion sensors of device are being utilized, the horizon of the user's real world 204 remains matched up to the virtual panoramic reality horizon 203 in the view of the panorama 306.

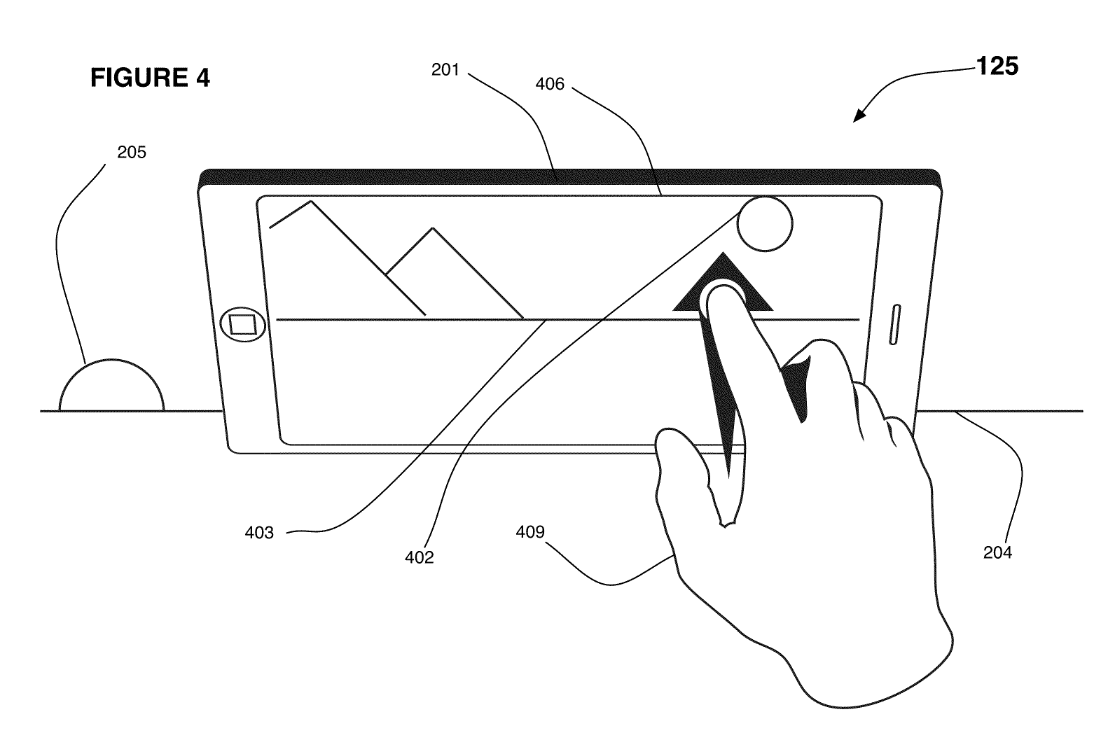

In step 125 and as illustrated by FIG. 4, the user has employed a secondary device control method 409 to alter the view of the panoramic image 406 such that the virtual panoramic reality horizon 403 is now offset by some significant amount relative to the user's real world horizon 204. In other words, the real world FOV of device 201 and virtual panoramic reality FOV have been disassociated.

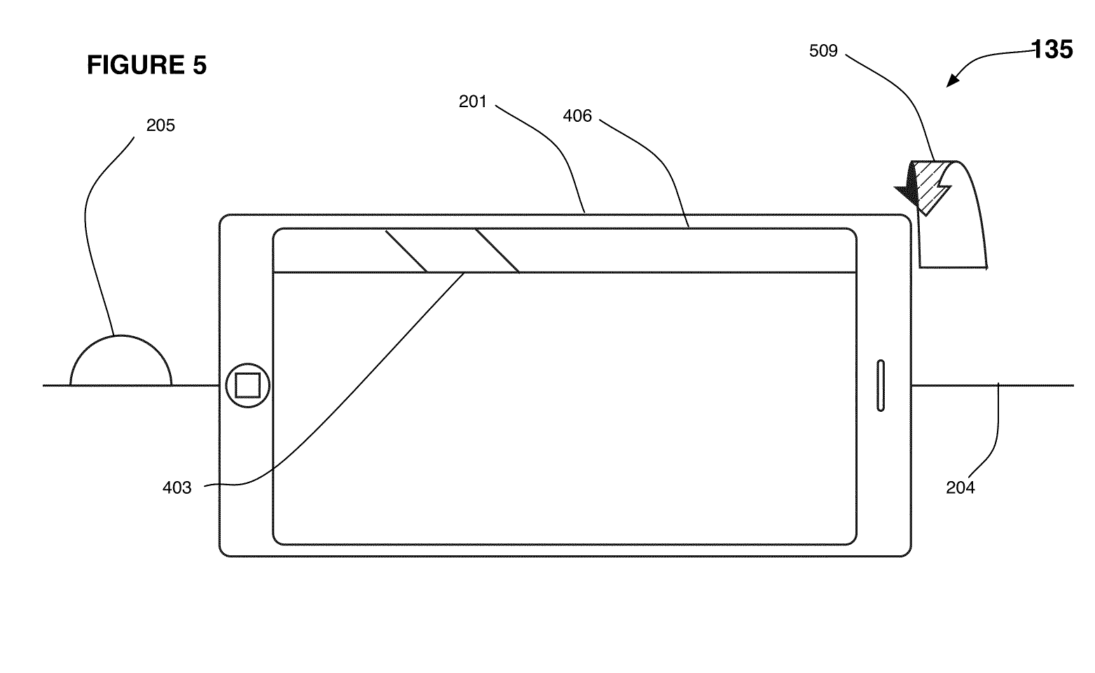

As illustrated FIG. 5, the disassociation problem is exacerbated by the user when the motion sensors on the device 201 detect the rotation of the device 201 back to its original orientation 509. At this point, it is evident how the apparent disconnect between the real world horizon 204 and virtual reality horizons 403 can be disorienting to the user.

In some embodiments, as long as the user maintains the current orientation of the device 201 and corresponding virtual panoramic reality image, the device 210 ceases to respond to small changes in the orientation of device 201 (step 130).

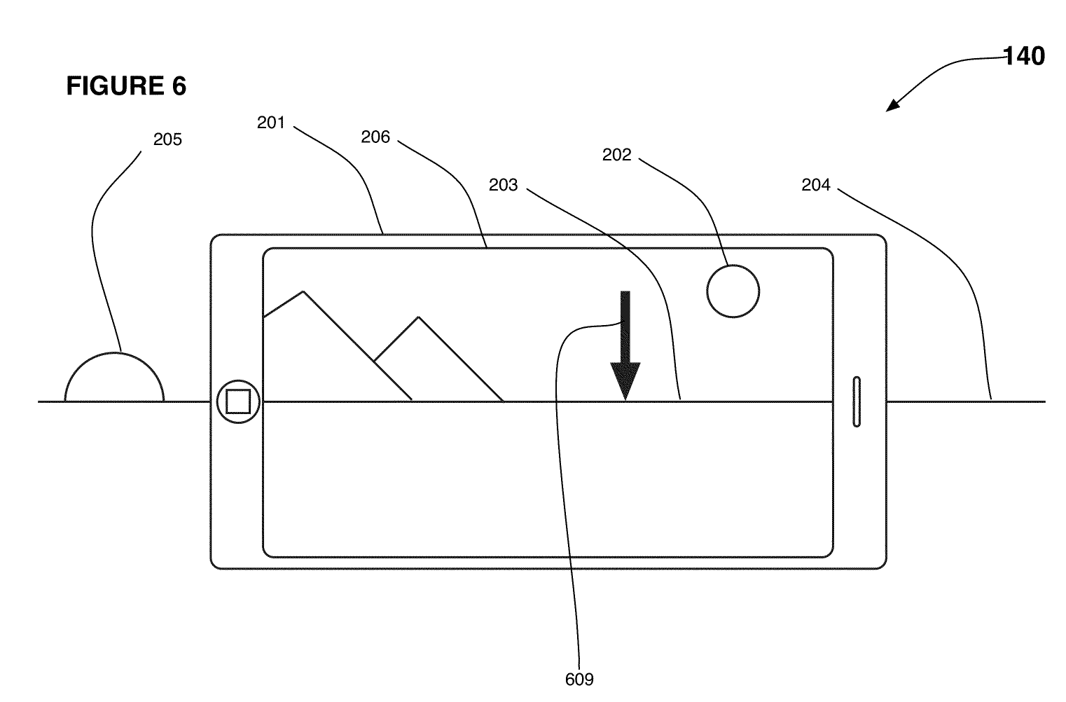

As illustrated by step 135, if and when the device 201 detects a substantial change in the orientation of device 201 greater than a disassociation threshold, then a reorientation of the virtual panoramic reality FOV of device 201 is initiated. As shown in FIG. 6, the direction 609 in which device 201 reorients the panoramic view to match the real world orientation is illustrated by the real world horizon 204 and virtual panoramic reality 203 (see step 140).

In some embodiments, this change in orientation occurs after some certain threshold of device movement from the device orientation sensor, so as not to disrupt the desired view when a secondary control method is used. Additionally, the gradual change in view can occur over some period of time so that it does not cause a jarring and unnatural shift in perspective, i.e., a smooth transition is generally desirable. Accordingly, the reorientation, when properly executed, can be performed unnoticed by the user. Conversely, in other implementations, it may be desirable for the reorientation to be relatively quick, e.g., instantaneous.

In some embodiments, the view of the panoramic environment can continue to respond to motion and/or orientation sensors until a certain movement/orientation threshold is met, at which point reorientation can occur.

In some embodiments, the reorientation feature can be manually enabled and/or disabled by the user. The movement threshold can also be user selectable and/or preset by the device manufacturer. It is also possible to manually activate the reorientation feature “as needed”, by for example, using a touch screen control or physically moving the device such as abrupt shake(s) or flick(s) of the device (like resetting an Etch-A-Sketch).

Additions and modification to the above described embodiments are possible. For example, in addition to correcting for the vertical orientation of the device horizon, it is also possible to correct for roll, heading/yaw or for other previous image control resulting in one or more changes in the device image orientation and image transformations such as scaling, focus, depth of view, and focal length, and also includes image changes resulting from zooming, tilting, and leveling.

In sum, the present invention provides a system and methods for maintaining a meaningful and desirable orientation for the cropped or full view of a panoramic image when two or more methods for controlling the view are employed. The advantages of such a system include the ability to easily switch between touch and motion-sensor controlled views without becoming disoriented.

While this invention has been described in terms of several embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. In a computerized display device, a computerized method for reorientation of panoramic images in a limited field-of-view immersive viewing environment, the method comprising:
orientating a device to affect the field of view (FOV) of a corresponding virtual panoramic reality FOV;
executing a user command resulting in a disassociation of the orientation within the immersive viewing environment and the orientation of the device in the real world;
changing a method of controlling the orientation of the panoramic FOV to a method through which the user command was issued;
tracking the change in orientation;
detecting when the change in orientation exceeds a threshold, and if so, re-orientate the virtual panoramic reality orientation and FOV to correspond to device orientation and implied FOV.

2. The method of claim 1 wherein the reorientation is gradual.

3. The method of claim 1 wherein the control of the limited FOV of an immersive panoramic viewing environment can be controlled by reorienting of the device can be enabled and disabled by a user.

4. The method of claim 1 wherein the device movement threshold is user selectable.

5. The method of claim 1 wherein controlling the limited FOV of an immersive panoramic viewing environment by reorienting of the device is controlled by at least one motion detector of the device.

6. The method of claim 1 wherein the disassociation is caused by a user control.

7. The method of claim 1 wherein the reorientation of the virtual panoramic reality orientation and FOV can be activated manually by the user.

8. In a computerized display device, a computerized method for reorientation of panoramic images in an immersive viewing environment, the method comprising:
orientating a device field of view (FOV) of a display device to a corresponding virtual panoramic reality FOV;
executing a user command resulting in a disassociation of the device FOV from the virtual panoramic reality FOV;
tracking the disassociation between the device FOV and virtual panoramic reality FOV; and
detecting the disassociation between the device FOV and virtual reality FOV exceeds a disassociation threshold, and if so, reorienting the device FOV to correspond to the virtual panoramic reality FOV.

9. The method of claim 8 wherein the reorienting of the device FOV can be enabled and disabled by a user.

10. The method of claim 8 wherein the disassociation threshold is user selectable.

11. The method of claim 8 wherein orientating of the device FOV (or displayed) field of view (FOV) to a corresponding virtual panoramic reality FOV is controlled by at least one motion detector of the device.

12. A computerized mobile device configured to re-orientate the limited FOV of panoramic images in an immersive viewing environment, the mobile device comprising:
a motion detector configured to detect motion and/or orientation of the display device;
a display configured to orientate a virtual panoramic reality FOV to a corresponding device orientation, wherein the orientation is based on the detected motion and/or orientation of the mobile device; and
a processor configured to:
receive a user command resulting in a disassociation of the device orientation from the virtual panoramic reality FOV;
track the change in device orientation and virtual panoramic reality FOV; and
when the change in orientation exceeds a threshold, and if so, re-orientate the virtual panoramic reality orientation and FOV to correspond to device orientation and implied FOV.

13. The mobile device of claim 12 wherein the reorientation is gradual.

14. The mobile device of claim 12 wherein the reorienting of the virtual panoramic reality orientation and FOV can be enabled and disabled by a user.

15. The mobile device of claim 12 wherein the disassociation threshold is user selectable.

16. The mobile device of claim 12 wherein orientating of the virtual panoramic reality orientation and FOV to a corresponding device orientation is controlled by at least one motion and/or orientation detector of the device.

17. The mobile device of claim 12 wherein the disassociation is caused by a user control.

18. The mobile device of claim 11 wherein the reorientation of the virtual panoramic reality orientation and FOV can be activated manually by the user.
